(19) United States
(12) Patent Application Publication
(10) Pub. No.: US 2025/0274006 A1
(43) Pub. Date: Aug. 28, 2025

(54) MOTOR COIL SUBSTRATE AND MOTOR

(71) Applicant: IBIDEN CO., LTD., Ogaki (JP)

(72) Inventors: Takahisa HIRASAWA, Ogaki (JP); Takayuki FURUNO, Ogaki (JP)

(73) Assignee: IBIDEN CO., LTD., Ogaki (JP)

(21) Appl. No.: 19/180,705

(22) Filed: Apr. 16, 2025

Related U.S. Application Data
(63) Continuation of application No. PCT/JP2022/038930, filed on Oct. 19, 2022.

(51) Int. Cl. H02K 3/28

(52) U.S. Cl. CPC H02K 3/28; H02K 2213/03

(57) ABSTRACT

A motor coil substrate includes a flexible substrate, and coils including wirings such that the wirings are formed on a first surface of the flexible substrate and a second surface on the opposite side with respect to the first surface. The flexible substrate is wound circumferentially from one end of a longitudinal direction of a flexible substrate around an axis extending in a direction perpendicular to the longitudinal direction of the flexible substrate such that the flexible substrate is formed into a cylindrical shape and that a cylindricity of an outer circumferential surface is greater than 0.0 mm and equal to or less than 0.3 mm.

### CROSS-REFERENCE TO RELATED APPLICATIONS

The present application is a continuation of and claims the benefit of priority to International Application No. PCT/JP2022/038930, filed Oct. 19, 2022, the entire contents of which are incorporated herein by reference.

### BACKGROUND OF THE INVENTION

### Field of the Invention

A technology disclosed in the present specification relates to a motor coil substrate, and a motor formed using the motor coil substrate.

### Description of Background Art

Japanese Patent Application Laid-Open Publication No. 2022-43581 describes a coil substrate having a flexible substrate and spiral-shaped coils formed on both sides of the flexible substrate. The entire contents of this publication are incorporated herein by reference.

### SUMMARY OF THE INVENTION

According to one aspect of the present invention, a motor coil substrate includes a flexible substrate, and coils including wirings such that the wirings are formed on a first surface of the flexible substrate and a second surface on the opposite side with respect to the first surface. The flexible substrate is wound circumferentially from one end of a longitudinal direction of a flexible substrate around an axis extending in a direction perpendicular to the longitudinal direction of the flexible substrate such that the flexible substrate is formed into a cylindrical shape and that a cylindricity of an outer circumferential surface is greater than 0.0 mm and equal to or less than 0.3 mm.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a plan view schematically illustrating a coil substrate according to an embodiment of the present invention;

FIG. 2 is a cross-sectional view schematically illustrating a coil substrate according to an embodiment of the present invention;

FIG. 3A is a plan view schematically illustrating U-phase coils in a coil substrate according to an embodiment of the present invention;

FIG. 3B is a plan view schematically illustrating V-phase coils in a coil substrate according to an embodiment of the present invention;

FIG. 3C is a plan view schematically illustrating W-phase coils in a coil substrate according to an embodiment of the present invention;

FIG. 4 is a plan view comparing the U phase, V phase, and W phase of a coil substrate according to an embodiment of the present invention;

FIG. 5 is a plan view illustrating a simplified version of a coil substrate according to an embodiment of the present invention;

FIG. 6 is a perspective view schematically illustrating a motor coil substrate according to an embodiment of the present invention;

FIG. 7 is an explanatory diagram schematically illustrating positions of terminals on a motor coil substrate according to an embodiment of the present invention;

FIG. 8 is an enlarged view of a portion of FIG. 7;

FIG. 9 is a cross-sectional view schematically illustrating a motor according to an embodiment of the present invention;

FIG. 10 is a plan view schematically illustrating a coil substrate of a modified example according to an embodiment of the present invention; and

FIG. 11 is a bottom view schematically illustrating the coil substrate of the modified example.

### DETAILED DESCRIPTION OF THE EMBODIMENTS

Embodiments will now be described with reference to the accompanying drawings, wherein like reference numerals designate corresponding or identical elements throughout the various drawings.

### Embodiment

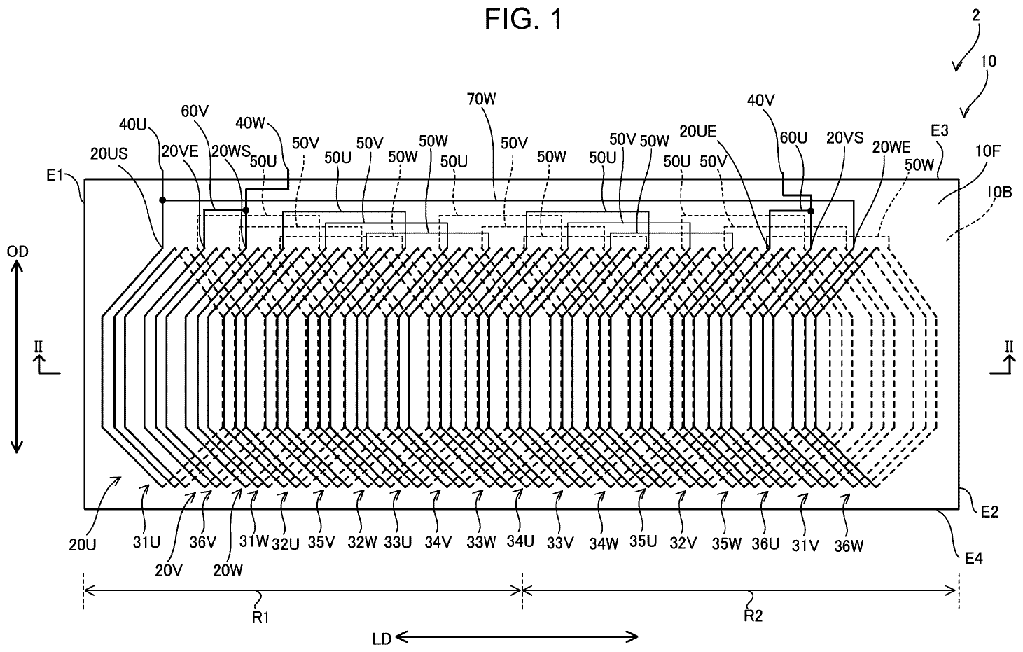

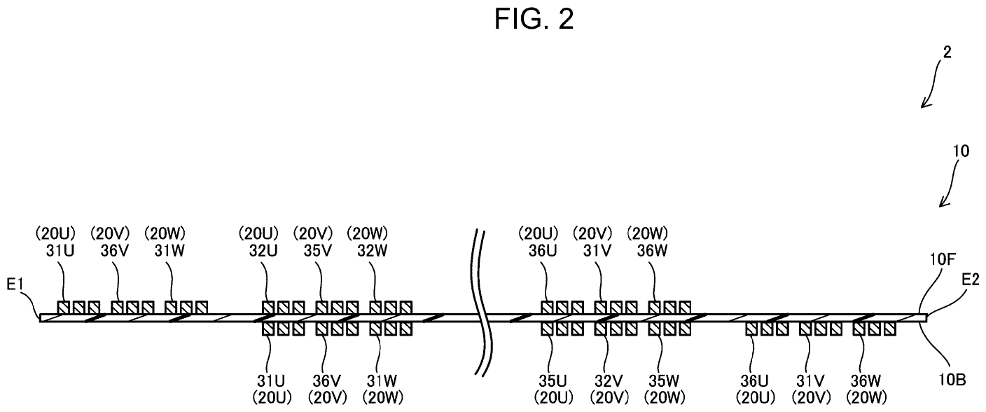

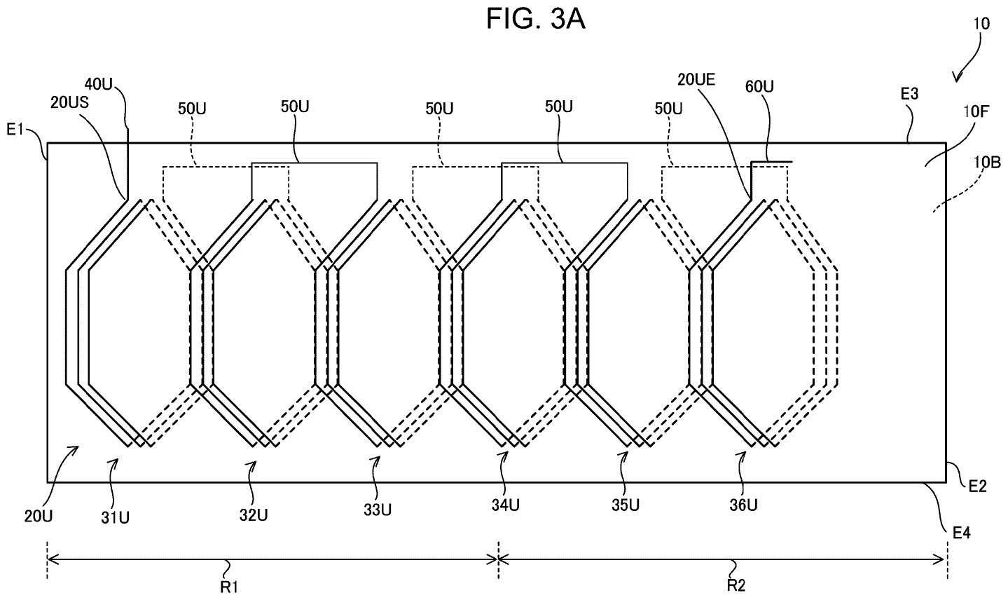

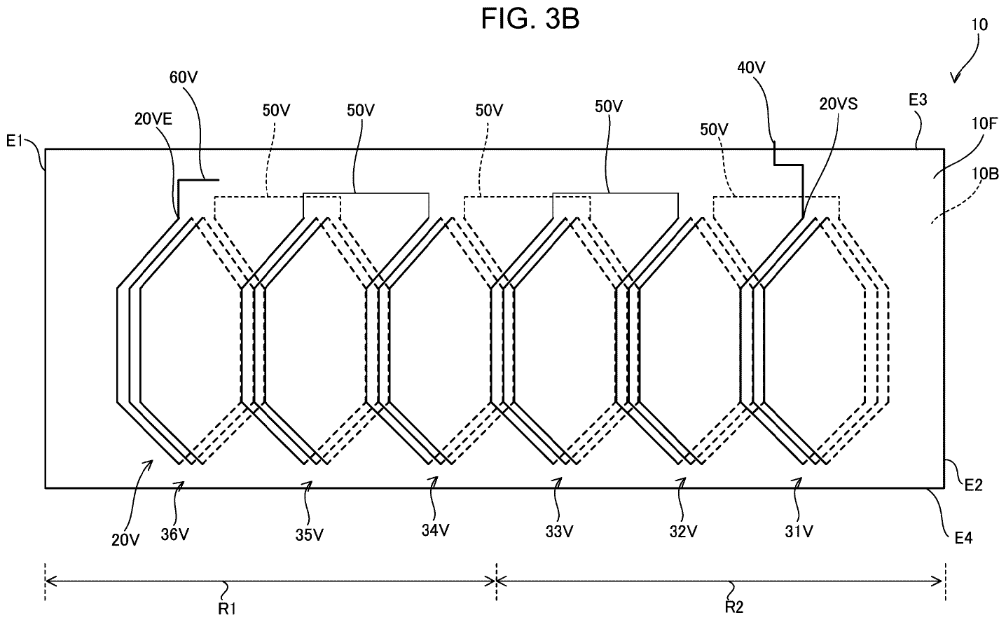

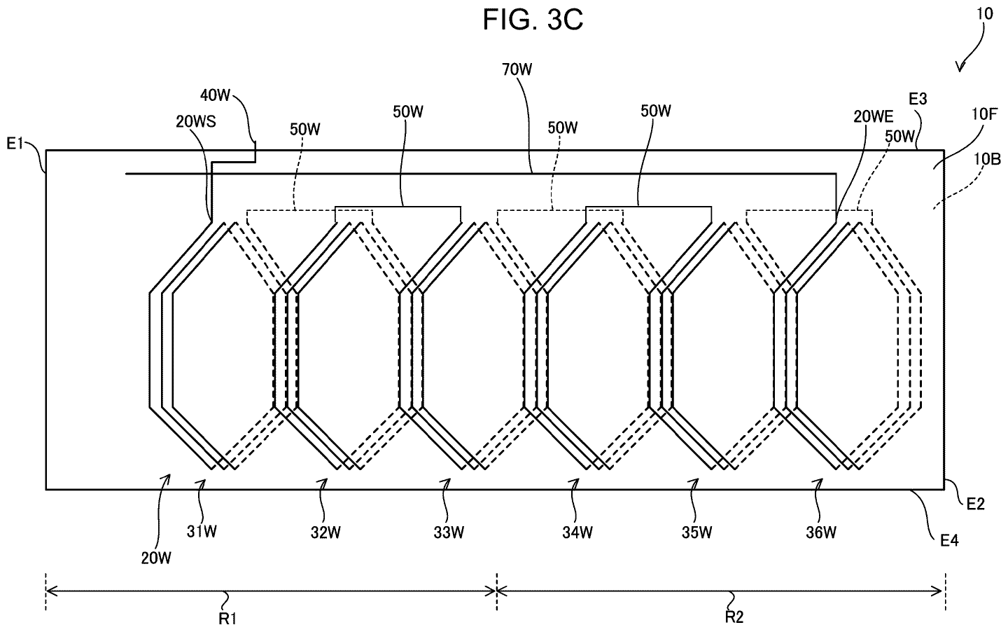

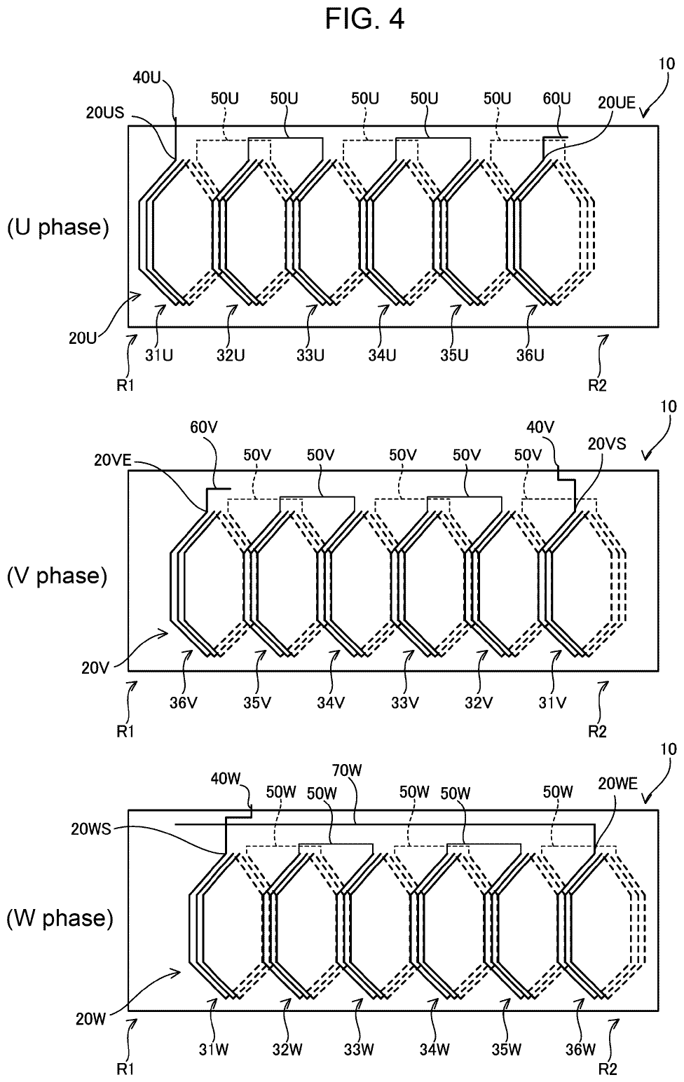

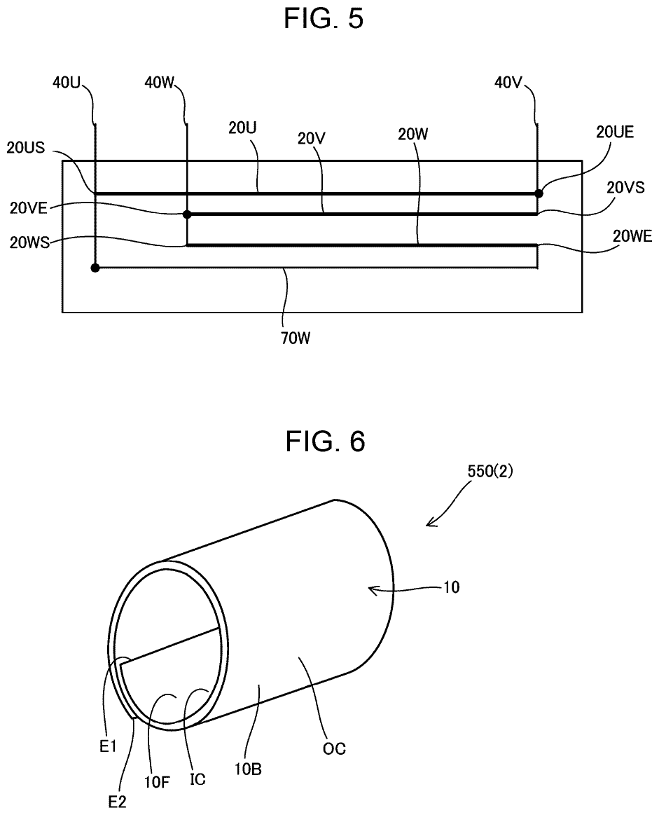

FIG. 1 is a plan view illustrating a coil substrate 2 according to an embodiment of the present invention. FIG. 2 is a cross-sectional view between II-II of FIG. 1. FIGS. 3A-3C are plan views illustrating a U-phase coil (20U), a V-phase coil (20V), and a W-phase coil (20W), respectively. FIG. 4 illustrates plan views comparing the U phase, the V phase, and the W phase of the coil substrate 2 of the embodiment. FIG. 5 is a plan view illustrating a simplified version of the coil substrate 2 of FIG. 1.

As illustrated in FIG. 1, the coil substrate 2 has a flexible substrate 10, a U-phase coil (20U), a V-phase coil (20V), a W-phase coil (20W), a U-phase terminal (40U), a V-phase terminal (40V), a W-phase terminal (40W), multiple inter-coil connection wirings (50U, 50V, 50W), multiple interphase connection wirings (60U, 60V), and a return wire (70W).

The flexible substrate 10 is a resin substrate having a first surface (10F) and a second surface (10B) on the opposite side with respect to the first surface (10F). The flexible substrate 10 is formed using an insulating resin such as polyimide or polyamide. The flexible substrate 10 is flexible. The flexible substrate 10 is formed in a rectangular shape having four sides, first side (E1)-fourth side (E4). The first side (E1) is a short side on one end side of the flexible substrate 10 in a longitudinal direction (arrow (LD) direction in FIG. 1). The second side (E2) is a short side on the other end side in the longitudinal direction. The first side (E1) and the second side (E2) are short sides extending along an orthogonal direction (arrow (OD) direction in FIG. 1) that is orthogonal to the longitudinal direction. The third side (E3) and the fourth side (E4) are long sides extending in the longitudinal direction. As will be described in detail later, when the coil substrate 2 is wound into a cylindrical shape to form a motor coil substrate 550 (see FIG. 6), the first surface (10F) is positioned on an inner circumferential side and the second surface (10B) is positioned on an outer circumferential side.

The flexible substrate 10 has a first region (R1) on one end side (first side (E1) side) in the longitudinal direction, and a second region (R2) adjacent to the first region (R1). The second region (R2) includes the second side (E2).

The U-phase terminal (40U), the V-phase terminal (40V), and the W-phase terminal (40W) are all formed on the third side (E3) of the flexible substrate 10. In the embodiment, the U-phase terminal (40U) and the W-phase terminal (40W) are formed in the first region (R1). The V-phase terminal (40V) is formed in the second region (R2). As illustrated in FIG. 1, the U-phase terminal (40U) is connected to a starting end (20US) of the U-phase coil (20U). At the same time, the U-phase terminal (40U) is connected to an ending end (20WE) of the W-phase coil (20W) via the return wiring (70W). The V-phase terminal (40V) is connected to a starting end (20VS) of the V-phase coil (20V). At the same time, the V-phase terminal (40V) is connected to an ending end (20UE) of the U-phase coil (20U) via the inter-phase connection wiring (60U). The W-phase terminal (40W) is connected to a starting end (20WS) of the W-phase coil (20W). At the same time, the W-phase terminal (40W) is connected to an ending end (20VE) of the V-phase coil (20V) via the inter-phase connection wiring (60V). That is, in the embodiment, the U-phase coil (20U), the V-phase coil (20V), and the W-phase coil (20W) are A-connected (see FIG. 5). In examples, the U-phase coil (20U), the V-phase coil (20V), and the W-phase coil (20W) may be Y-connected or may be otherwise connected.

The U-phase coil (20U), the V-phase coil (20V), and the W-phase coil (20W) respectively constitute the U phase, the V phase, and the W phase of a three-phase motor.

As illustrated in FIGS. 1, 3A, and 4, the starting end (20US) of the U-phase coil (20U) is positioned in the first region (R1). The ending end (20UE) of the U-phase coil (20U) is formed in the second region (R2). As illustrated in FIG. 3A, the U-phase coil (20U) includes six coils (31U, 32U, 33U, 34U, 35U, 36U). The six coils (31U-36U) are formed in this order from the starting end (20US) to the ending end (20UE) of the U-phase coil (20U) (from the first region (R1) to the second region (R2)). The six coils (31U-36U) are connected to each other by the inter-coil connection wirings (50U).

The six coils (31U-36U) are each formed by forming a first wiring, which forms a half turn of one turn, on the first surface (10F) side, forming a second wiring, which forms the remaining half turn of the one turn, on the second surface (10B) side, and forming adjacent turns in a staggered manner. The first wiring and the second wiring are electrically connected via a via conductor that penetrates the flexible substrate 10.

Winding start positions (starting ends) of the first coil (31U), the third coil (33U), and the fifth coil (35U) from the starting end (20US) of the U-phase coil (20U) are formed on the first surface (10F), and winding end positions (terminating ends) thereof are formed on the second surface (10B). When the flexible substrate 10 is viewed from the first surface (10F) side, the coils (31U, 33U, 35U) are wound counterclockwise.

On the other hand, winding start positions (starting ends) of the second coil (32U), the fourth coil (34U), and the sixth coil (36U) from the starting end (20US) of the U-phase coil (20U) are formed on the second surface (10B), and winding end positions (terminating ends) thereof are formed on the first surface (10F). When the flexible substrate 10 is viewed from the first surface (10F) side, the coils (32U, 34U, 36U) are wound clockwise.

As illustrated in FIGS. 2, 3A, and 1, a portion of the wiring (second wiring) of the coil (31U) overlaps a portion of the wiring (first wiring) of the adjacent coil (32U) via the flexible substrate 10. Similarly, a portion of the wiring (second wiring) of the coil (32U) overlaps a portion of the wiring (first wiring) of the adjacent coil (33U). A portion of the wiring (second wiring) of the coil (33U) overlaps a portion of the wiring (first wiring) of the adjacent coil (34U). A portion of the wiring (second wiring) of the coil (34U) overlaps a portion of the wiring (first wiring) of the adjacent coil (35U). A portion of the wiring (second wiring) of the coil (35U) overlaps a portion of the wiring (first wiring) of the adjacent coil (36U).

As illustrated in FIGS. 3A and 1, the inter-coil connection wiring (50U) connecting the coil (31U) and the coil (32U), the inter-coil connection wiring (50U) connecting the coil (33U) and the coil (34U), and the inter-coil connection wiring (50U) connecting the coil (35U) and the coil (36U) are formed on the second surface (10B). On the other hand, the inter-coil connection wiring (50U) connecting the coil (32U) and the coil (33U) and the inter-coil connection wiring (50U) connecting the coil (34U) and the coil (35U) are formed on the first surface (10F). The U-phase terminal (40U) and the inter-phase connection wiring (60U) are formed on the first surface (10F).

As illustrated in FIGS. 1, 3B, and 4, the starting end (20VS) of the V-phase coil (20V) is formed in the second region (R2). The ending end (20VE) of the V-phase coil (20V) is formed in the first region (R1). As illustrated in FIG. 3B, the V-phase coil (20V) includes six coils (31V, 32V, 33V, 34V, 35V, 36V). The six coils (31V-36V) are formed in this order from the starting end (20VS) to the ending end (20VE) of the V-phase coil (20V) (from the second region (R2) to the first region (R1)). The six coils (31V-36V) are connected to each other by the inter-coil connection wirings (50V).

The six coils (31V-36V) are each formed by forming a first wiring, which forms a half turn of one turn, on the first surface (10F) side, forming a second wiring, which forms the remaining half turn of the one turn, on the second surface (10B) side, and forming adjacent turns in a staggered manner. The first wiring and the second wiring are electrically connected via a via conductor that penetrates the flexible substrate 10.

Winding start positions (starting ends) of the first coil (31V), the third coil (33V), and the fifth coil (35V) from the starting end (20VS) of the V-phase coil (20V) are formed on the first surface (10F), and winding end positions (terminating ends) thereof are formed on the second surface (10B). When the flexible substrate 10 is viewed from the first surface (10F) side, the coils (31V, 33V, 35V) are wound counterclockwise.

On the other hand, winding start positions (starting ends) of the second coil (32V), the fourth coil (34V), and the sixth coil (36V) from the starting end (20VS) of the V-phase coil (20V) are formed on the second surface (10B), and winding end positions (terminating ends) thereof are formed on the first surface (10F). When the flexible substrate 10 is viewed from the first surface (10F) side, the coils (32V, 34V, 36V) are wound clockwise.

As illustrated in FIGS. 2, 3B, and 1, a portion of the wiring (first wiring) of the coil (31V) overlaps a portion of the wiring (second wiring) of the adjacent coil (32V) via the flexible substrate 10. Similarly, a portion of the wiring (first wiring) of the coil (32V) overlaps a portion of the wiring (second wiring) of the adjacent coil (33V). A portion of the wiring (first wiring) of the coil (33V) overlaps a portion of the wiring (second wiring) of the adjacent coil (34V). A portion of the wiring (first wiring) of the coil (34V) overlaps a portion of the wiring (second wiring) of the adjacent coil (35V). A portion of the wiring (first wiring) of the coil (35V) overlaps a portion of the wiring (second wiring) of the adjacent coil (36V).

As illustrated in FIGS. 3B and 1, the inter-coil connection wiring (50V) connecting the coil (31V) and the coil (32V), the inter-coil connection wiring (50V) connecting the coil (33V) and the coil (34V), and the inter-coil connection wiring (50V) connecting the coil (35V) and the coil (36V) are formed on the second surface (10B). On the other hand, the inter-coil connection wiring (50V) connecting the coil (32V) and the coil (33V) and the inter-coil connection wiring (50V) connecting the coil (34V) and the coil (35V) are formed on the first surface (10F). The V-phase terminal (40V) and the inter-phase connection wiring (60V) are formed on the first surface (10F).

As illustrated in FIGS. 1, 3C, and 4, the starting end (20WS) of the W-phase coil (20W) is formed in the first region (R1). The ending end (20WE) of the W-phase coil (20W) is formed in the second region (R2). As illustrated in FIG. 3C, the W-phase coil (20W) includes six coils (31W, 32W, 33W, 34W, 35W, 36W). The six coils (31W-36W) are formed in this order from the starting end (20WS) to the ending end (20WE) of the W-phase coil (20W) (from the first region (R1) to the second region (R2)). The six coils (31W-36W) are connected to each other by the inter-coil connection wirings (50W).

The six coils (31W-36W) are each formed by forming a first wiring, which forms a half turn of one turn, on the first surface (10F) side, forming a second wiring, which forms the remaining half turn of the one turn, on the second surface (10B) side, and forming adjacent turns in a staggered manner. The first wiring and the second wiring are electrically connected via a via conductor that penetrates the flexible substrate 10.

Winding start positions (starting ends) of the first coil (31W), the third coil (33W), and the fifth coil (35W) from the starting end (20WS) of the W-phase coil (20W) are formed on the first surface (10F), and winding end positions (terminating ends) thereof are formed on the second surface (10B). When the flexible substrate 10 is viewed from the first surface (10F) side, the coils (31W, 33W, 35W) are wound counterclockwise.

On the other hand, winding start positions (starting ends) of the second coil (32W), the fourth coil (34W), and the sixth coil (36W) from the starting end (20WS) of the W-phase coil (20W) are formed on the second surface (10B), and winding end positions (terminating ends) thereof are formed on the first surface (10F). When the flexible substrate 10 is viewed from the first surface (10F) side, the coils (32W, 34W, 36W) are wound clockwise.

As illustrated in FIGS. 2, 3C, and 1, a portion of the wiring (second wiring) of the coil (31W) overlaps a portion of the wiring (first wiring) of the adjacent coil (32W) via the flexible substrate 10. Similarly, a portion of the wiring (second wiring) of the coil (32W) overlaps a portion of the wiring (first wiring) of the adjacent coil (33W). A portion of the wiring (second wiring) of the coil (33W) overlaps a portion of the wiring (first wiring) of the adjacent coil (34W). A portion of the wiring (second wiring) of the coil (34W) overlaps a portion of the wiring (first wiring) of the adjacent coil (35W). A portion of the wiring (second wiring) of the coil (35W) overlaps a portion of the wiring (first wiring) of the adjacent coil (36W).

As illustrated in FIGS. 3C and 1, the inter-coil connection wiring (50W) connecting the coil (31W) and the coil (32W), the inter-coil connection wiring (50W) connecting the coil (33W) and the coil (34W), and the inter-coil connection wiring (50W) connecting the coil (35W) and the coil (36W) are formed on the second surface (10B). On the other hand, the inter-coil connection wiring (50W) connecting the coil (32W) and the coil (33W) and the inter-coil connection wiring (50W) connecting the coil (34W) and the coil (35W) are formed on the first surface (10F). W-phase terminal (40W) and the return wiring (70W) are formed on the first surface (10F).

As illustrate in FIGS. 3C, 5, and 1, the return wiring (70W) connects between the ending end (20WE) of the W-phase coil (20W) and the U-phase terminal (40U). The return wiring (70W) extends from the second region (R2) to the first region (R1).

Although not illustrated, the first surface (10F), and the wirings of the coils (20U, 20V, 20W), the inter-coil connection wirings (50U, 50V, 50W), the inter-phase connection wirings (60U, 60V), and the return wiring (70W), which are formed on the first surface (10F), are covered by a resin insulation layer. Similarly, the second surface (10B), and the wirings of the coils (20U, 20V, 20W) and the inter-coil connection wirings (50U, 50V, 50W), which are formed on the second surface (10B), are covered by a resin insulation layer.

As illustrated in FIGS. 1 and 3A-3C, in the embodiment, the wirings of the coils (20U, 20V, 20W) are each formed in a hexagonal shape. In other examples, the wirings of the coils (20U, 20V, 20W) may be formed in any shape, such as a circle (perfect circle, ellipse), a triangle, a quadrangle (square, rectangle, rhombus), a pentagon, or a polygon with seven or more sides. Further, it is not limited to having identical wiring formation shapes for all the coils; the wiring formation shapes may differ between the coils. The number of turns in one coil wiring may be one or more, and is preferably 3 or more and 7 or less. A coil wiring is formed by forming a half turn on the first surface, forming a half turn on the second surface, and connecting them via a through hole. Further, it is also possible to form a half turn on the second surface and form a half turn on the first surface. In this case, a half turn refers to half of a coil wiring. Further, it is possible to form a ¼ turn on the first surface and a ¼ turn on the second surface, connect them via a through hole, and form a total of a half turn on either the first surface or the second surface. Further, a coil wiring may be formed on either the first surface or the second surface. In this case, it is possible that a coil wiring on the first surface and a coil wiring on the second surface fully or partially overlap, or do not overlap.

The coil substrate 2 of the embodiment can be manufactured using any method. For example, the coil substrate 2 may be formed using a tenting method using a flexible substrate having a conductor layer (metal foil) as a starting material. In another example, the coil substrate 2 may be obtained by forming a metal layer on a flexible substrate using a printing or dispensing method. In yet another example, the coil substrate 2 may be obtained by forming a flexible material and a metal layer using a 3D printer.

FIG. 6 is a perspective view schematically illustrating a motor coil substrate 550 formed using the coil substrate 2 of the embodiment (FIGS. 1-5). As illustrated in FIG. 6, the motor coil substrate 550 for a motor is formed by winding the coil substrate 2 of the embodiment (FIGS. 1-5) into a cylindrical shape. When the coil substrate 2 is wound into a cylindrical shape, the coil substrate 2 is wound multiple turns around an axis extending in the orthogonal direction (an axis extending parallel to the first side (E1)) with the first side (E1) (FIG. 1) as a starting point. Further, the number of turns the coil substrate is wound is not particularly limited. When the coil substrate 2 is wound into a cylindrical shape, the first surface (10F) of the flexible substrate 10 is positioned on the inner circumferential side, and the second surface (10B) is positioned on the outer circumferential side.

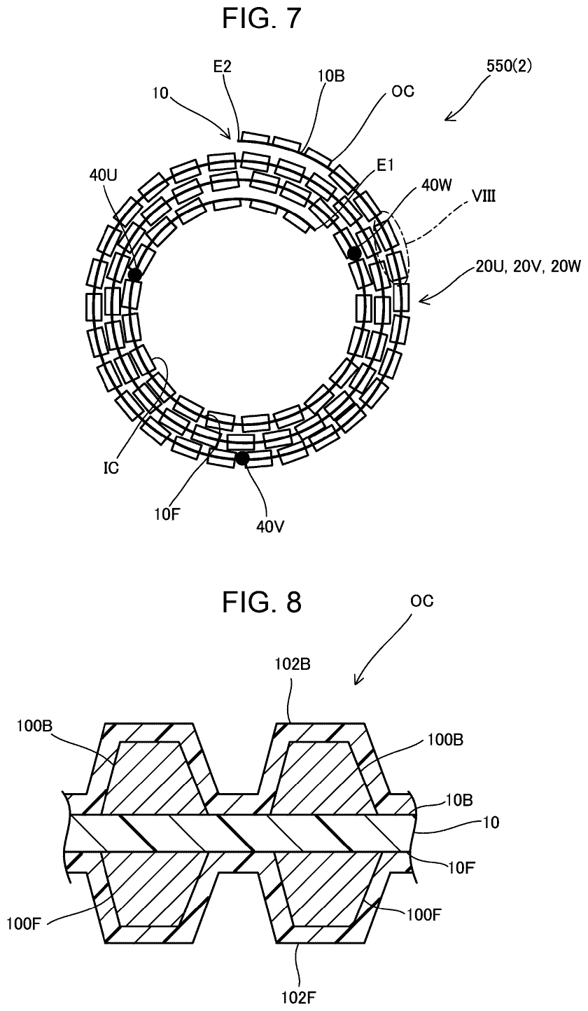

FIG. 7 schematically illustrates positions of the terminals when the motor coil substrate 550 is viewed along an axial direction. As illustrated in FIG. 7, the U-phase terminal (40U), the V-phase terminal (40V), and the W-phase terminal (40W) are formed at substantially 120-degree intervals in a circumferential direction. The U-phase terminal (40U) and the W-phase terminal (40W) are formed on an inner circumferential surface. The V-phase terminal (40V) is formed on an outer circumferential surface. FIG. 7 illustrates that a conductor layer in a wound state overlaps with a conductor layer on an outer side thereof. However, it is also possible that a conductor layer partially overlaps with a conductor layer on an outer side thereof, or a conductor layer does not overlap with a conductor layer on an outer side thereof.

FIG. 8 is an enlarged view of a portion (VIII) in FIG. 7, illustrating an example of a structure of a terminal. As illustrated in FIG. 8, conductor layers (100F, 100B) of the coils (20U, 20V, 20W) are respectively formed on both sides of the flexible substrate 10, and insulating films (102F, 102B) are respectively formed on the conductor layers (100F, 100B) of the coils (20U, 20V, 20W). By forming the insulating films (102F, 102B), the conductor layers (100F, 100B) are not exposed, and there is no contact between adjacent conductor layers (100F, 100B) or between adjacent conductor layers (100F, 100B) in a cross section when the coil substrate 2 is wound, and thus, insulation is maintained. The insulating films (102F, 102B) can be formed by printing a liquid resin. An example of the resin is polyimide. In FIG. 8, the insulating films (102F, 102B) are formed so as to follow the conductor layers (100F, 100B), but may also be formed so as to cover upper surfaces of the conductor layers (100F, 100B) and fill spaces between the conductor layers (100F, 100B). The insulating layers (102F, 102B) are not particularly limited in thickness, but are preferably formed to each have a thickness of about 1 μm or more and 30 μm or less. In FIG. 8, the conductor layers (100F, 100B) are symmetrically formed with the flexible substrate 10 sandwiched in between. However, it is also possible that the conductor layers (100F, 100B) partially overlap each other with the flexible substrate 10 sandwiched in between, or do not overlap each other with the flexible substrate 10 sandwiched in between. Further, in FIG. 8, a cross-sectional shape of each of the conductor layers (100F, 100B) is a trapezoid. However, it is also possible that the cross-sectional shape of each of the conductor layers (100F, 100B) is a square, a rectangle, or a quadrangle. The conductor layers (100F, 100B) may have the same cross-sectional shape, or may have different cross-sectional shapes.

In this case, a cross section of the motor coil substrate 550 is composed of the flexible substrate 10, the conductor layers, which are the wirings of the phases, and the insulating layers, which cover the conductor layers. In this case, a result obtained by calculating a cross-sectional area of all the conductor layers in a cross-sectional area of the motor coil substrate 550 is a space factor of the coils. In this case, the space factor of the coils in the cross section of the motor coil substrate 550 is 50% or more and 99% or less. A high space factor of the coil conductors is ensured. Therefore, when a motor is formed using the motor coil substrate 550 of the embodiment, high torque can be obtained. A high-performance motor can be obtained. In this case, a method for calculating the space factor of the coils is: Space factor = ((sum of cross-sectional areas of conductor parts)/(coil cross-sectional area))×100.

FIG. 7 illustrates an outer circumferential surface (OC) and an inner circumferential surface (IC) of the motor coil substrate 550. In the embodiment, a cylindricity of the outer circumferential surface (OC) of the motor coil substrate 550 is greater than 0.0 mm and equal to or less than 0.3 mm. When the cylindricity of the outer circumferential surface (OC) is greater than 0.0 mm and equal to or less than 0.3 mm, the motor coil substrate 550 does not roll evenly on a flat surface. When the cylindricity of the outer circumferential surface (OC) is greater than 0.0 mm and equal to or less than 0.3 mm, the adhesion strength with the yoke during motor formation is increased. A motor with stable performance can be obtained. Further, the cylindricity of the outer circumferential surface (OC) of the motor coil substrate 550 is preferably greater than 0.0 mm and equal to or less than 0.2 mm. When the cylindricity of the outer circumferential surface (OC) is greater than 0.0 mm and equal to or less than 0.2 mm, the adhesion strength with the yoke during motor formation can be increased and stability can be improved. Therefore, even when it is operated as a motor, the motor coil substrate 550 is not positionally displaced, and a motor with stable performance can be obtained.

The cylindricity of the outer circumferential surface (OC) is measured using a V-block measurement method. That is, the cylindricity of the outer circumferential surface (OC) is measured by placing the motor coil substrate 550 on a V-block, rotating it one turn, measuring a deviation in a direction perpendicular to the axis at five different locations, and calculating an average value thereof.

The combined coil space factor of the coils (20U, 20V, 20W) in a cross section of the motor coil substrate 550 is 50% or more and 99% or less. By using a motor coil substrate 550 with a space factor of 50% or more and 99% or less, a high-torque motor can be obtained. Further, when the motor coil substrate 550 of the embodiment is applied to a small motor, torque can be increased, and a high-performance motor can be obtained. In the present specification, a small motor refers to a motor with an outer diameter of 50 mm or less.

Further, the space factor of the coils in a cross section of the motor coil substrate 550 is preferably 55% or more and 90% or less. By using a motor coil substrate 550 with a coil space factor of 55% or more and 90% or less, a high-torque motor can be obtained. Further, when the motor coil substrate 550 of the embodiment is applied to a small motor, torque can be increased, and a high-performance motor can be obtained.

Further, the space factor of the coils in a cross section of the motor coil substrate 550 is more preferably 60% or more and 80% or less. A high space factor of the coil conductors can be ensured, and when it is wound into a cylindrical shape, a predetermined cylindrical shape can be achieved. Further, a high space factor of the coil conductors can be ensured even in a small motor, and when it is wound into a cylindrical shape, a predetermined cylindrical shape can be achieved, torque can be increased, and a high-performance motor can be obtained.

A ratio of the wirings (that is, the wirings of the coils (20U, 20V, 20W)) in a total weight of the motor coil substrate 550 is 80.0% or more and 99.9% or less. A high-torque motor can be obtained by using a motor coil substrate 550 with the ratio of the wirings in the total weight being 80.0% or more and 99.9% or less. In this case, a method for calculating the ratio of the wirings in the total weight of the motor coil substrate 550 is: Wiring ratio=((total weight of conductor part)/(weight of coil substrate))×100.

Further, the ratio of the wirings in the total weight of the motor coil substrate 550 is preferably 85.0% or more and 96.0% or less. Since the wiring ratio is 85.0% or more and 96.0% or less, a high space factor of the coil conductors can be ensured, and when it is wound into a cylindrical shape, a predetermined cylindrical shape can be achieved.

Further, a high space factor of the coil conductors can be ensured even in a small motor, and when it is wound into a cylindrical shape, a predetermined cylindrical shape can be achieved, torque can be increased, and a high-performance motor can be obtained.

The outer circumferential surface (OC) of the motor coil substrate 550 is formed of the flexible substrate 10, and the wirings of the coils (20U, 20V, 20W) are not exposed. That is, an insulating layer that covers the wirings is formed on the outermost circumference of the motor coil substrate 550. The outer circumferential surface (OC) of the motor coil substrate 550 is insulated from the outside.

When the motor coil substrate 550 is formed, the number of turns of the coil substrate 2 is arbitrary. The number of turns of the coil substrate 2 is preferably 2 or more and 10 or less. By setting the number of turns to 2 or more and 10 or less, the cylindricity of the outer circumferential surface (OC) of the formed motor coil substrate 550 is greater than 0.0 mm and equal to or less than 0.3 mm, as described above. As a result, deterioration in motor performance can be suppressed.

The cylindricity of the outer circumferential surface (OC) of the motor coil substrate 550 is greater than 0.0 mm and equal to or less than 0.3 mm, and the space factor of the coils in a cross section of the motor coil substrate 550 is 50% or more and 99% or less. In the motor coil substrate 550 of the embodiment of the present invention, the cylindricity of the outer circumferential surface (OC) is greater than 0.0 mm and equal to or less than 0.3 mm and the space factor of the coils is 50% or more and 99% or less, and when a motor is formed using the motor coil substrate 550, the adhesion strength with the yoke during motor formation can be increased, and high torque can be obtained. A high-performance motor can be obtained. Further, when the motor coil substrate 550 of the embodiment is applied to a small motor, torque can be increased, and a high-performance motor can be obtained.

It is preferable that the cylindricity of the outer circumferential surface (OC) of the motor coil substrate 550 is greater than 0.0 mm and equal to or less than 0.3 mm, and the space factor of the coils in a cross section of the motor coil substrate 550 is 55% or more and 90% or less. By using a motor coil substrate 550 in which the cylindricity of the outer circumferential surface (OC) is greater than 0.0 mm and equal to or less than 0.3 mm and the space factor of the coils is 55% or more and 90% or less, the adhesion strength with the yoke during motor formation can be increased, and a high-torque motor can be obtained. A high-performance motor can be obtained. Further, when the motor coil substrate 550 of the embodiment is applied to a small motor, torque can be increased, and a high-performance motor can be obtained.

Further, it is preferable that the cylindricity of the outer circumferential surface (OC) of the motor coil substrate 550 is greater than 0.0 mm and equal to or less than 0.3 mm, and the space factor of the coils in a cross section of the motor coil substrate 550 is 60% or more and 80% or less. Since the cylindricity of the outer circumferential surface (OC) of the motor coil substrate 550 is greater than 0.0 mm and equal to or less than 0.3 mm and the space factor of the coils in a cross section of the motor coil substrate 550 is 60% or more and 80% or less, a high space factor of the coil conductors can be ensured, and when it is wound into a cylindrical shape, a predetermined cylindrical shape can be achieved. The adhesion strength with the yoke during motor formation can be increased, and high torque can be obtained. A high-performance motor can be obtained. Further, a high space factor of the coil conductors can be ensured even in a small motor, and when it is wound into a cylindrical shape, a predetermined cylindrical shape can be achieved, the adhesion strength with the yoke during motor formation can be increased, torque can be increased, and a high-performance motor can be obtained. Further, when the motor coil substrate 550 of the embodiment is applied to a small motor, torque can be increased, and a high-performance motor can be obtained.

It is preferable that the cylindricity of the outer circumferential surface (OC) of the motor coil substrate 550 is greater than 0.0 mm and equal to or less than 0.2 mm and the space factor of the coils in a cross section of the motor coil substrate 550 is 50% or more and 99% or less. Since the cylindricity of the outer circumferential surface (OC) of the motor coil substrate 550 is greater than 0.0 mm and equal to or less than 0.2 mm and the space factor of the coils in a cross section of the motor coil substrate 550 is 50% or more and 99% or less, a high space factor of the coil conductors can be ensured, and when it is wound into a cylindrical shape, a predetermined cylindrical shape can be achieved. The adhesion strength with the yoke during motor formation can be increased, and high torque can be obtained. A high-performance motor can be obtained. Further, a high space factor of the coil conductors can be ensured even in a small motor, and when it is wound into a cylindrical shape, a predetermined cylindrical shape can be achieved, the adhesion strength with the yoke during motor formation can be increased, and stability can be improved. Therefore, even when it is operated as a motor, the motor coil substrate 550 is not positionally displaced, torque can be increased, and a high-performance motor can be obtained. Further, when the motor coil substrate 550 of the embodiment is applied to a small motor, torque can be increased, and a high-performance motor can be obtained.

It is preferable that the cylindricity of the outer circumferential surface (OC) of the motor coil substrate 550 is greater than 0.0 mm and equal to or less than 0.2 mm and the space factor of the coils in a cross section of the motor coil substrate 550 is 55% or more and 90% or less. Since the cylindricity of the outer circumferential surface (OC) of the motor coil substrate 550 is greater than 0.0 mm and equal to or less than 0.2 mm and the space factor of the coils in a cross section of the motor coil substrate 550 is 55% or more and 90% or less, a high space factor of the coil conductors can be ensured, and when it is wound into a cylindrical shape, a predetermined cylindrical shape can be achieved. The adhesion strength with the yoke during motor formation can be increased, and high torque can be obtained. A high-performance motor can be obtained. Further, a high space factor of the coil conductors can be ensured even in a small motor, and when it is wound into a cylindrical shape, a predetermined cylindrical shape can be achieved, the adhesion strength with the yoke during motor formation can be increased, and stability can be improved. Therefore, even when it is operated as a motor, the motor coil substrate 550 is not positionally displaced, torque can be increased, and a high-performance motor can be obtained. Further, when the motor coil substrate 550 of the embodiment is applied to a small motor, torque can be increased, and a high-performance motor can be obtained.

It is preferable that the cylindricity of the outer circumferential surface (OC) of the motor coil substrate 550 is greater than 0.0 mm and equal to or less than 0.2 mm and the space factor of the coils in a cross section of the motor coil substrate 550 is 60% or more and 80% or less. Since the cylindricity of the outer circumferential surface (OC) of the motor coil substrate 550 is greater than 0.0 mm and equal to or less than 0.2 mm and the space factor of the coils in a cross section of the motor coil substrate 550 is 60% or more and 80% or less, a high space factor of the coil conductors can be ensured, and when it is wound into a cylindrical shape, a predetermined cylindrical shape can be achieved. The adhesion strength with the yoke during motor formation can be increased, and high torque can be obtained. A high-performance motor can be obtained. Further, a high space factor of the coil conductors can be ensured even in a small motor, and when it is wound into a cylindrical shape, a predetermined cylindrical shape can be achieved, the adhesion strength with the yoke during motor formation can be increased, and stability can be improved. Therefore, even when it is operated as a motor, the motor coil substrate 550 is not positionally displaced, torque can be increased, and a high-performance motor can be obtained. Further, when the motor coil substrate 550 of the embodiment is applied to a small motor, torque can be increased, and a high-performance motor can be obtained.

The cylindricity of the outer circumferential surface (OC) of the motor coil substrate 550 is greater than 0.0 mm and equal to or less than 0.3 mm, and the ratio of the wirings in a total weight of the motor coil substrate 550 is 80.0% or more and 99.9% or less. When a motor is formed using the motor coil substrate 550 in which the cylindricity of the outer circumferential surface (OC) is greater than 0.0 mm and equal to or less than 0.3 mm and the ratio of the wirings in the total weight of the motor coil substrate 550 is 80.0% or more and 99.9% or less, the space factor of the coils can be increased and high torque can be obtained. A high-performance motor can be obtained. Further, when the motor coil substrate 550 of the embodiment is applied to a small motor, torque can be increased, and a high-performance motor can be obtained.

Further, the cylindricity of the outer circumferential surface (OC) of the motor coil substrate 550 is greater than 0.0 mm and equal to or less than 0.3 mm, and the ratio of the wirings in the total weight of the motor coil substrate 550 is 85.0% or more and 96.0% or less. When a motor is formed using the motor coil substrate 550 in which the cylindricity of the outer circumferential surface (OC) is greater than 0.0 mm and equal to or less than 0.3 mm and the ratio of the wirings in the total weight of the motor coil substrate 550 is 85.0% or more and 96.0% or less, the ratio of the wirings can be increased while a predetermined cylindrical shape can be achieved. As a result, the adhesion strength with the yoke during motor formation can be increased, the space factor of the coils can be increased, and high torque can be obtained. A high-performance motor can be obtained. Further, when the motor coil substrate 550 of the embodiment is applied to a small motor, torque can be increased, and a high-performance motor can be obtained.

The cylindricity of the outer circumferential surface (OC) of the motor coil substrate 550 is greater than 0.0 mm and equal to or less than 0.2 mm, and the ratio of the wirings in the total weight of the motor coil substrate 550 is 80.0% or more and 99.9% or less. When a motor is formed using the motor coil substrate 550 of the embodiment in which the cylindricity of the outer circumferential surface (OC) of the motor coil substrate 550 is greater than 0.0 mm and equal to or less than 0.2 mm and the ratio of the wirings in the total weight is 80.0% or more and 99.9% or less, the ratio of the wirings can be increased while a predetermined cylindrical shape can be achieved. As a result, the adhesion strength with the yoke during motor formation can be increased, the space factor of the coils can be increased, and high torque can be obtained. A high-performance motor can be obtained. Further, when the motor coil substrate 550 of the embodiment is applied to a small motor, torque can be increased, and a high-performance motor can be obtained.

Further, the cylindricity of the outer circumferential surface (OC) of the motor coil substrate 550 is greater than 0.0 mm and equal to or less than 0.2 mm, and the ratio of the wirings in the total weight of the motor coil substrate 550 is 85.0% or more and 96.0% or less. When a motor is formed using the motor coil substrate 550 of the embodiment in which the cylindricity of the outer circumferential surface (OC) of the motor coil substrate 550 is greater than 0.0 mm and equal to or less than 0.2 mm and the ratio of the wirings in the total weight is 85.0% or more and 96.0% or less, the ratio of the wirings can be increased and the space factor of the coils can be increased, while a predetermined cylindrical shape can be achieved and high torque can be obtained. As a result, the adhesion strength with the yoke during motor formation can be increased, and stability can be improved. Therefore, even when it is operated as a motor, the motor coil substrate 550 is not positionally displaced, and a motor with stable performance can be obtained. Further, when the motor coil substrate 550 of the embodiment is applied to a small motor, torque can be increased, and a high-performance motor can be obtained.

The space factor of the coils in a cross section of the motor coil substrate 550 is 50% or more and 99% or less, and the ratio of the wirings in the total weight of the motor coil substrate 550 is 80.0% or more and 99.9% or less. In the motor coil substrate 550 of the embodiment, the space factor of the coils is 50% or more and 99% or less, and the ratio of the wirings in the total weight of the motor coil substrate 550 is 80.0% or more and 99.9% or less. By using the motor coil substrate, the space factor of the coils can be increased and high torque can be obtained. A high-performance motor can be obtained. Further, when the motor coil substrate 550 of the embodiment is applied to a small motor, torque can be increased, and a high-performance motor can be obtained.

It is preferable that the space factor of the coils in a cross section of the motor coil substrate 550 is 55% or more and 90% or less, and the ratio of the wirings in the total weight of the motor coil substrate 550 is 85.0% or more and 96.0% or less. By using the motor coil substrate 550 in which the space factor of the coils is 55% or more and 90% or less and the ratio of the wirings in the total weight of the motor coil substrate 550 is 85.0% or more and 96.0% or less, the space factor of the coils can be increased and a high-torque motor can be obtained. A high-performance motor can be obtained. Further, when the motor coil substrate 550 of the embodiment is applied to a small motor, torque can be increased, and a high-performance motor can be obtained.

Further, it is preferable that the space factor of the coils in a cross section of the motor coil substrate 550 is 60% or more and 80% or less, and the ratio of the wirings in the total weight of the motor coil substrate 550 is 85.0% or more and 96.0% or less. Since the space factor of the coils is 60% or more and 80% or less, and the ratio of the wirings in the total weight of the motor coil substrate 550 is 85.0% or more and 96.0% or less, a high space factor of the coil conductors can be ensured, and when it is wound into a cylindrical shape, a predetermined cylindrical shape can be achieved. High torque can be obtained. A high-performance motor can be obtained. Further, a high space factor of the coil conductors can be ensured even in a small motor, and when it is wound into a cylindrical shape, a predetermined cylindrical shape can be achieved, torque can be increased, and a high-performance motor can be obtained. Further, when the motor coil substrate 550 of the embodiment is applied to a small motor, torque can be increased, and a high-performance motor can be obtained.

The cylindricity of the outer circumferential surface (OC) of the motor coil substrate 550 is greater than 0.0 mm and equal to or less than 0.3 mm, the space factor of the coils in a cross section of the motor coil substrate 550 is 50% or more and 99% or less, and the ratio of the wirings in the total weight of the motor coil substrate 550 is 80.0% or more and 99.9% or less. In the motor coil substrate 550 of the embodiment, the cylindricity of the outer circumferential surface (OC) of the motor coil substrate 550 is greater than 0.0 mm and equal to or less than 0.3 mm, the space factor of the coils is 50% or more and 99% or less, and the ratio of the wirings in the total weight of the motor coil substrate 550 is 80.0% or more and 99.9% or less. When a motor is formed using the motor coil substrate, the space factor of the coils can be increased and high torque can be obtained. The adhesion strength with the yoke during motor formation can be increased, and high torque can be obtained. A high-performance motor can be obtained. Further, when the motor coil substrate 550 of the embodiment is applied to a small motor, torque can be increased, and a high-performance motor can be obtained.

Further, it is preferable that the cylindricity of the outer circumferential surface (OC) of the motor coil substrate 550 is greater than 0.0 mm and equal to or less than 0.3 mm, the space factor of the coils in a cross section of the motor coil substrate 550 is 55% or more and 90% or less, and the ratio of the wirings in the total weight of the motor coil substrate 550 is 80.0% or more and 99.9% or less. By using the motor coil substrate 550 in which the cylindricity of the outer circumferential surface (OC) of the motor coil substrate 550 is greater than 0.0 mm and equal to or less than 0.3 mm, the space factor of the coils is 55% or more and 90% or less, and the ratio of the wirings in the total weight of the motor coil substrate 550 is 80.0% or more and 99.9% or less, the space factor of the coils can be increased, a predetermined cylindrical shape can be achieved, and a high-torque motor can be obtained. Therefore, even when it is operated as a motor, a motor with stable performance can be obtained. Further, when the motor coil substrate 550 of the embodiment is applied to a small motor, torque can be increased, and a high-performance motor can be obtained.

It is preferable that the cylindricity of the outer circumferential surface (OC) of the motor coil substrate 550 is greater than 0.0 mm and equal to or less than 0.3 mm, the space factor of the coils in a cross section of the motor coil substrate 550 is 60% or more and 80% or less, and the ratio of the wirings in the total weight of the motor coil substrate 550 is 80.0% or more and 99.0% or less. By using the motor coil substrate 550 in which the cylindricity of the outer circumferential surface (OC) of the motor coil substrate 550 is greater than 0.0 mm and equal to or less than 0.3 mm, the space factor of the coils is 60% or more and 80% or less, and the ratio of the wirings in the total weight of the motor coil substrate 550 is 80.0% or more and 99.9% or less, the space factor of the coils can be increased, a predetermined cylindrical shape can be achieved, and a high-torque motor can be obtained. Therefore, even when it is operated as a motor, a motor with stable performance can be obtained. Further, when the motor coil substrate 550 of the embodiment is applied to a small motor, torque can be increased, and a high-performance motor can be obtained.

The cylindricity of the outer circumferential surface (OC) of the motor coil substrate 550 is greater than 0.0 mm and equal to or less than 0.2 mm, the space factor of the coils in a cross section of the motor coil substrate 550 is 50% or more and 99% or less, and the ratio of the wirings in the total weight of the motor coil substrate 550 is 80.0% or more and 99.9% or less. In the motor coil substrate 550 of the embodiment, the cylindricity of the outer circumferential surface (OC) of the motor coil substrate 550 is greater than 0.0 mm and equal to or less than 0.2 mm, the space factor of the coils is 50% or more and 99% or less, and the ratio of the wirings in the total weight of the motor coil substrate 550 is 80.0% or more and 99.9% or less. When a motor is formed using the motor coil substrate 550, the space factor of the coils can be increased and high torque can be obtained. The adhesion strength with the yoke during motor formation can be increased, and high torque can be obtained. A high-performance motor can be obtained. Further, when the motor coil substrate 550 of the embodiment is applied to a small motor, torque can be increased, and a high-performance motor can be obtained.

Further, it is preferable that the cylindricity of the outer circumferential surface (OC) of the motor coil substrate 550 is greater than 0.0 mm and equal to or less than 0.2 mm, the space factor of the coils in a cross section of the motor coil substrate 550 is 55% or more and 90% or less, and the ratio of the wirings in the total weight of the motor coil substrate 550 is 80.0% or more and 99.9% or less. By using the motor coil substrate 550 in which the cylindricity of the outer circumferential surface (OC) of the motor coil substrate 550 is greater than 0.0 mm and equal to or less than 0.2 mm, the space factor of the coils is 55% or more and 90% or less, and the ratio of the wirings in the total weight of the motor coil substrate 550 is 80.0% or more and 99.9% or less, the space factor of the coils can be increased, a predetermined cylindrical shape can be achieved, and a high-torque motor can be obtained. Therefore, even when it is operated as a motor, a motor with stable performance can be obtained. Further, when the motor coil substrate 550 of the embodiment is applied to a small motor, torque can be increased, and a high-performance motor can be obtained.

It is preferable that the cylindricity of the outer circumferential surface (OC) of the motor coil substrate 550 is greater than 0.0 mm and equal to or less than 0.2 mm, the space factor of the coils in a cross section of the motor coil substrate 550 is 60% or more and 80% or less, and the ratio of the wirings in the total weight of the motor coil substrate 550 is 80.0% or more and 99.0% or less. By using the motor coil substrate 550 in which the cylindricity of the outer circumferential surface (OC) of the motor coil substrate 550 is greater than 0.0 mm and equal to or less than 0.2 mm, the space factor of the coils is 60% or more and 80% or less, and the ratio of the wirings in the total weight of the motor coil substrate 550 is 80.0% or more and 99.9% or less, the space factor of the coils can be increased, a predetermined cylindrical shape can be achieved, and a high-torque motor can be obtained. Therefore, even when it is operated as a motor, a motor with stable performance can be obtained. Further, when the motor coil substrate 550 of the embodiment is applied to a small motor, torque can be increased, and a high-performance motor can be obtained.

It is preferable that the cylindricity of the outer circumferential surface (OC) of the motor coil substrate 550 is greater than 0.0 mm and equal to or less than 0.3 mm, the space factor of the coils in a cross section of the motor coil substrate 550 is 50% or more and 99% or less, and the ratio of the wirings in the total weight of the motor coil substrate 550 is 85.0% or more and 96.0% or less. When a motor is formed using the motor coil substrate 550 in which the cylindricity of the outer circumferential surface (OC) of the motor coil substrate 550 is greater than 0.0 mm and equal to or less than 0.3 mm, the space factor of the coils is 50% or more and 99% or less, and the ratio of the wirings in the total weight of the motor coil substrate 550 is 85.0% or more and 96.0% or less, the space factor of the coils can be increased and high torque can be obtained. The adhesion strength with the yoke during motor formation can be increased, and high torque can be obtained. A high-performance motor can be obtained. Further, when the motor coil substrate 550 of the embodiment is applied to a small motor, torque can be increased, and a high-performance motor can be obtained.

Further, it is preferable that the cylindricity of the outer circumferential surface (OC) of the motor coil substrate 550 is greater than 0.0 mm and equal to or less than 0.3 mm, the space factor of the coils in a cross section of the motor coil substrate 550 is 55% or more and 90% or less, and the ratio of the wirings in the total weight of the motor coil substrate 550 is 85.0% or more and 96.0% or less. By using the motor coil substrate 550 in which the cylindricity of the outer circumferential surface (OC) of the motor coil substrate 550 is greater than 0.0 mm and equal to or less than 0.3 mm, the space factor of the coils is 55% or more and 90% or less, and the ratio of the wirings in the total weight of the motor coil substrate 550 is 85.0% or more and 96.0% or less, the space factor of the coils can be increased, a predetermined cylindrical shape can be achieved, and a high-torque motor can be obtained. Therefore, even when it is operated as a motor, a motor with stable performance can be obtained. Further, when the motor coil substrate 550 of the embodiment is applied to a small motor, torque can be increased, and a high-performance motor can be obtained.

Further, it is preferable that the cylindricity of the outer circumferential surface (OC) of the motor coil substrate 550 is greater than 0.0 mm and equal to or less than 0.3 mm, the space factor of the coils in a cross section of the motor coil substrate 550 is 60% or more and 80% or less, and the ratio of the wirings in the total weight of the motor coil substrate 550 is 85.0% or more and 96.0% or less. Since the cylindricity of the outer circumferential surface (OC) of the motor coil substrate 550 is greater than 0.0 mm and equal to or less than 0.3 mm, the space factor of the coils is 60% or more and 80% or less, and the ratio of the wirings in the total weight of the motor coil substrate 550 is 85.0% or more and 96.0% or less, a high space factor of the coil conductors can be ensured, and when it is wound into a cylindrical shape, a predetermined cylindrical shape can be achieved. High torque can be obtained. As a result, the adhesion strength with the yoke during motor formation can be increased. Therefore, even when it is operated as a motor, a motor with stable performance can be obtained. When the motor coil substrate 550 of the embodiment is applied to a small motor, torque can be increased, and a high-performance motor can be obtained.

The cylindricity of the outer circumferential surface (OC) of the motor coil substrate 550 is greater than 0.0 mm and equal to or less than 0.2 mm, the space factor of the coils in a cross section of the motor coil substrate 550 is 50% or more and 99% or less, and the ratio of the wirings in the total weight of the motor coil substrate 550 is 85.0% or more and 96.0% or less. In the motor coil substrate 550 of the embodiment, the cylindricity of the outer circumferential surface (OC) of the motor coil substrate 550 is greater than 0.0 mm and equal to or less than 0.2 mm, the space factor of the coils is 50% or more and 99% or less, and the ratio of the wirings in the total weight of the motor coil substrate 550 is 85.0% or more and 96.0% or less. When a motor is formed using the motor coil substrate 550, the space factor of the coils can be increased and high torque can be obtained. The adhesion strength with the yoke during motor formation can be increased, and high torque can be obtained. A high-performance motor can be obtained. Further, when the motor coil substrate 550 of the embodiment is applied to a small motor, torque can be increased, and a high-performance motor can be obtained.

Further, it is preferable that the cylindricity of the outer circumferential surface (OC) of the motor coil substrate 550 is greater than 0.0 mm and equal to or less than 0.2 mm, the space factor of the coils in a cross section of the motor coil substrate 550 is 55% or more and 90% or less, and the ratio of the wirings in the total weight of the motor coil substrate 550 is 85.0% or more and 96.0% or less. By using the motor coil substrate 550 in which the cylindricity of the outer circumferential surface (OC) of the motor coil substrate 550 is greater than 0.0 mm and equal to or less than 0.2 mm, the space factor of the coils is 55% or more and 90% or less, and the ratio of the wirings in the total weight of the motor coil substrate 550 is 85.0% or more and 96.0% or less, the space factor of the coils can be increased, a predetermined cylindrical shape can be achieved, and a high-torque motor can be obtained. Therefore, even when it is operated as a motor, a motor with stable performance can be obtained. Further, when the motor coil substrate 550 of the embodiment is applied to a small motor, torque can be increased, and a high-performance motor can be obtained.

Further, it is preferable that the cylindricity of the outer circumferential surface (OC) of the motor coil substrate 550 is greater than 0.0 mm and equal to or less than 0.2 mm, the space factor of the coils in a cross section of the motor coil substrate 550 is 60% or more and 80% or less, and the ratio of the wirings in the total weight of the motor coil substrate 550 is 85.0% or more and 96.0% or less. Since the cylindricity of the outer circumferential surface (OC) of the motor coil substrate 550 is greater than 0.0 mm and equal to or less than 0.2 mm, the space factor of the coils is 60% or more and 80% or less, and the ratio of the wirings in the total weight of the motor coil substrate 550 is 85.0% or more and 96.0% or less, a high space factor of the coil conductors can be ensured, and when it is wound into a cylindrical shape, a predetermined cylindrical shape can be achieved. High torque can be obtained. As a result, the adhesion strength with the yoke during motor formation can be increased, and stability can be improved. Therefore, even when it is operated as a motor, the motor coil substrate 550 is not positionally displaced, and a motor with stable performance can be obtained. When the motor coil substrate 550 of the embodiment is applied to a small motor, torque can be increased, and a high-performance motor can be obtained.

The motor coil substrate 550 of the embodiment is used in a slotless motor. In another example, the motor coil substrate 550 may be used in a motor other than a slotless motor.

A diameter of the outer circumferential surface (OC) (outer diameter of a cross section) of the motor coil substrate 550 is 50 mm or less. The diameter of the outer circumferential surface (OC) (outer diameter of a cross section) of the motor coil substrate 550 is preferably 30 mm or less. By forming a small motor using a motor coil substrate 550 with a diameter of 50 mm or less, degradation in motor performance can be effectively suppressed. The diameter of the outer circumferential surface (OC) of the motor coil substrate 550 is measured using a caliper. In the embodiment illustrated in FIG. 1, the space factor of the coils in a cross-sectional area of the motor coil substrate 550 is 70%. The ratio of the wirings in the total weight of the motor coil substrate 550 is 93%. The cylindricity of the outer circumferential surface (OC) is 0.1 mm. The diameter of the outer circumferential surface (OC) (outer diameter of a cross section) of the motor coil substrate 550 is 16 mm.

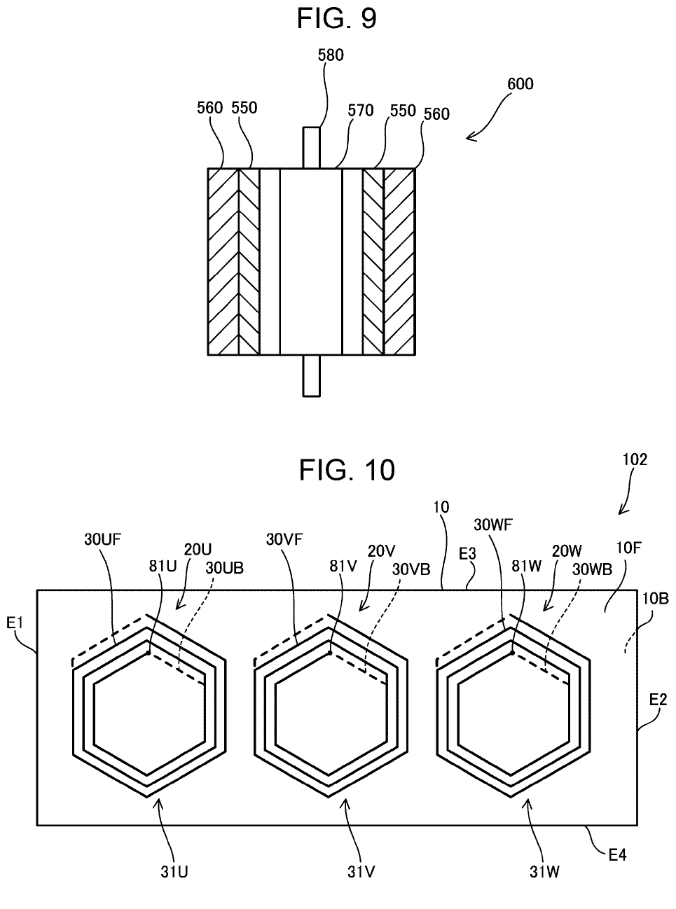

FIG. 9 is a cross-sectional view schematically illustrating a motor 600 formed using the motor coil substrate 550 of the embodiment (FIGS. 6-8). The motor 600 is formed by positioning the motor coil substrate 550 on an inner side of a yoke 560, and positioning a rotation shaft 580 and a magnet 570 fixed to the rotation shaft 580 on an inner side of the motor coil substrate 550. The motor 600 of the embodiment is a slotless motor.

In the above, the structures of the coil substrate 2 (FIGS. 1-5), the motor coil substrate 550 (FIGS. 6-8), and the motor 600 (FIG. 9) of the embodiment have been described. As described above, the cylindricity of the outer circumferential surface (OC) of the motor coil substrate 550 of the embodiment is greater than 0.0 mm and equal to or less than 0.3 mm. Therefore, when the motor 600 is formed using the motor coil substrate 550, the adhesion strength between the outer circumferential surface (OC) of the motor coil substrate 550 and the yoke 560 is higher than when the cylindricity of the outer circumferential surface is 0.0 mm. Even when a reaction force is exerted due to the rotation of the rotation shaft 580 and the magnet 570, the motor coil substrate 550 is unlikely to peel off from the yoke 560. In particular, when a small motor 600 is manufactured using the motor coil substrate 550 of the embodiment, a wider contact area between the outer circumferential surface (OC) of the motor coil substrate 550 and the yoke 560 is ensured, resulting in higher adhesion strength. Therefore, when the motor 600 is formed using the motor coil substrate 550 of the embodiment, stable motor performance can be obtained.

### Modified Example

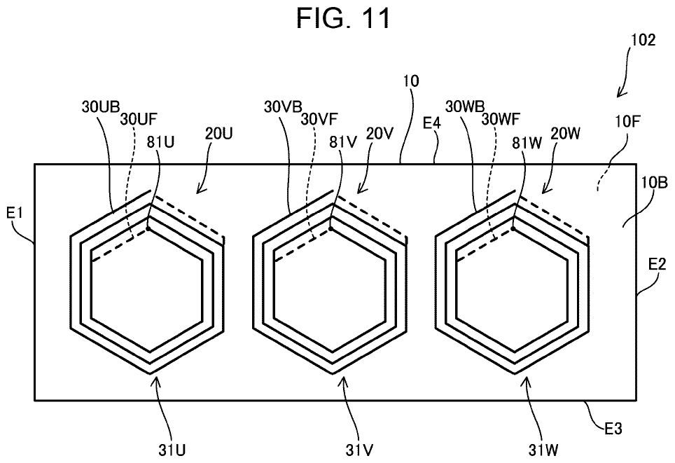

FIGS. 10 and 11 illustrate a modified example of the embodiment. FIG. 10 is a plan view illustrating a coil substrate 102 of the modified example. FIG. 11 is a bottom view illustrating the coil substrate 102 of the modified example. As illustrated in FIGS. 10 and 11, in the modified example, the formation of the wirings of the coils (31U, 31V, 31W) that form the U-phase coil (20U), the V-phase coil (20V), and the W-phase coil (20W) is different from that of the embodiment.

In FIGS. 10 and 11, only the coils (31U, 31V, 31W) are illustrated as the coils forming the U-phase coil (20U), the V-phase coil (20V), and the W-phase coil (20W). However, in reality, the U-phase coil (20U), the V-phase coil (20V), and the W-phase coil (20W) may be formed of multiple coils including the coils (31U, 31V, 31W). Further, in FIGS. 10 and 11, the U-phase terminal (40U), the V-phase terminal (40V), the W-phase terminal (40W), the inter-coil connection wirings (50U, 50V, 50W), the multiple inter-phase connection wirings (60U, 60V), and the return wiring (70W) are omitted from the illustration.

The coil (31U) forming the U-phase coil (20U) is formed of a coil-shaped first wiring (30UF) provided on the first surface (10F) (FIG. 10) and a coil-shaped second wiring (30UB) provided on the second surface (10B) (FIG. 11). The first wiring (30UF) and the second wiring (30UB) are electrically connected via a via conductor (81U) penetrating the flexible substrate 10. Similarly, the coil (20V) forming the V phase is formed of a first wiring (30VF) and a second wiring (30VB). The first wiring (30VF) and the second wiring (30VB) are electrically connected via a via conductor (81V). The coil (20W) forming the W phase is formed of a first wiring (30WF) and a second wiring (30WB). The first wiring (30WF) and the second wiring (30WB) are electrically connected via a via conductor (81W).

As illustrated in FIG. 10, the first wiring (30UF) is formed in a clockwise spiral shape (hexagonal spiral shape) from an outer circumference toward an inner circumference. The via conductor (81U) is formed at an inner circumference side end of the first wiring (30UF). As illustrated in FIG. 11, the second wiring (30UB) is formed in a counterclockwise spiral shape (hexagonal spiral shape) from an outer circumference toward an inner circumference. The via conductor (81U) is formed at an inner circumference side end of the second wiring (30UB). The first wiring (30UF) and the second wiring (30UB) are formed in spiral shapes wound in the same direction when viewed from the same surface. The first wiring (30UF) and the second wiring (30UB) overlap via the flexible substrate 10. The first wiring (30UF) and the second wiring (30UB) are electrically connected in series and function as one coil (31U).

The first wiring (30VF) and the second wiring (30VB), as well as the first wiring (30WF) and the second wiring (30WB), have the same relationship as the first wiring (30UF) and the second wiring (30UB) described above. The first wiring (30VF) and the second wiring (30VB) are formed in spiral shapes wound in the same direction when viewed from the same surface. The first wiring (30VF) and the second wiring (30VB) overlap via the flexible substrate 10. The first wiring (30VF) and the second wiring (30VB) are electrically connected in series and function as one coil (31V). The first wiring (30WF) and the second wiring (30WB) are formed in spiral shapes wound in the same direction when viewed from the same surface. The first wiring (30WF) and the second wiring (30WB) overlap via the flexible substrate 10. The first wiring (30WF) and the second wiring (30WB) are electrically connected in series and function as one coil (31W).

Although not illustrated, the first surface (10F) and the first wirings (30UF, 30VF, 30WF) are covered with a resin insulation layer. Similarly, the second surface (10B) and the second wirings (30UB, 30VB, 30WB) are covered with a resin insulation layer. In the present specification, a small motor refers to a motor with an outer diameter of 50 mm or less.

As illustrated in FIGS. 10 and 11, in the modified example, the wirings of the coils (20U, 20V, 20W) are each formed in a hexagonal shape. In other examples, the wirings of the coils (20U, 20V, 20W) may be formed in any shape, such as a circle (perfect circle, ellipse), a triangle, a quadrangle (square, rectangle, rhombus), a pentagon, or a polygon with seven or more sides. Further, it is not limited to having identical wiring formation shapes for all the coils; the wiring formation shapes may differ between the coils.

The coil substrate 102 of the modified example can be manufactured using any method. For example, the coil substrate 2 may be formed using a tenting method using a flexible substrate having a conductor layer (metal foil) as a starting material. In another example, the coil substrate 102 may be obtained by forming a metal layer on a flexible substrate using a printing or dispensing method. In yet another example, the coil substrate 102 may be obtained by forming a flexible material and a metal layer using a 3D printer.

A motor coil substrate 550 for a motor is formed by winding the coil substrate 102 of the modified example into a cylindrical shape (see FIGS. 6-8). The motor coil substrate 550 formed using the coil substrate 102 of the modified example has the same characteristics as the motor coil substrate 550 of the embodiment. Therefore, the motor coil substrate 550 of the modified example can achieve the same effect as the motor coil substrate 550 of the embodiment. In the modified example illustrated in FIGS. 10 and 11, the space factor of the coils in a cross-sectional area of the motor coil substrate 550 is 65%. The ratio of the wirings in the total weight of the motor coil substrate 550 is 91%. The cylindricity of the outer circumferential surface (OC) (see FIG. 7) is 0.1 mm. The diameter of the outer circumferential surface (OC) (outer diameter of a cross section) of the motor coil substrate 550 is 16 mm.

Japanese Patent Application Laid-Open Publication No. 2022-43581 describes a coil substrate having a flexible substrate and spiral-shaped coils formed on both sides of the flexible substrate. A motor coil substrate is formed by winding the coil substrate into a cylindrical shape. A motor is formed by positioning the formed motor coil substrate on an inner side of a cylindrical yoke, and positioning a rotation shaft and a magnet on an inner side of the motor coil substrate. The flexible substrate in Japanese Patent Application Laid-Open Publication No. 2022-43581 has a main portion where the coils are formed, and a sub portion where no coils are formed and which extends from the main portion. By adjusting a length of the sub portion, a thickness of the motor coil substrate is made uniform from 0° to 360°. It is thought that, in the technology of Japanese Patent Application Laid-Open Publication No. 2022-43581, by winding the motor coil substrate into a true cylindrical shape, a high-performance motor can be obtained.

However, it is thought that, in the technology of Japanese Patent Application Laid-Open Publication No. 2022-43581, adhesion strength between an outer circumferential surface of the motor coil substrate in a true cylindrical shape and the yoke is low. It is thought that, due to a reaction force caused by rotation of the shaft and the magnet, the motor coil substrate is likely to peel off from the yoke. As a result, it is thought that stable motor performance cannot be obtained. Further, in a case of a small motor, it is thought that stable motor performance cannot be obtained.

A motor coil substrate according to an embodiment of the present invention includes: a flexible substrate having a first surface and a second surface on the opposite side with respect to the first surface; and multiple coils formed by wirings provided on the first surface and the second surface. The motor coil substrate is formed into a cylindrical shape by being wound circumferentially around an axis extending in a direction perpendicular to a longitudinal direction of the flexible substrate, starting from a first end of the longitudinal direction of the flexible substrate. A cylindricity of an outer circumferential surface is greater than 0.0 mm and equal to or less than 0.3 mm.

In a motor coil substrate according to an embodiment of the present invention, the cylindricity of the outer circumferential surface is greater than 0.0 mm and equal to or less than 0.3 mm. Therefore, when a motor is formed using the motor coil substrate, the adhesion strength between the outer circumferential surface of the motor coil substrate and the yoke is higher than when the cylindricity of the outer circumferential surface is 0.0 mm. Even when a reaction force is exerted due to the rotation of the rotation shaft and the magnet, the motor coil substrate is unlikely to peel off from the yoke. In particular, when a small motor is manufactured using a motor coil substrate according to an embodiment of the present invention, a wider contact area between the outer circumferential surface of the motor coil substrate and the yoke is ensured, resulting in higher adhesion strength. Therefore, when a motor is formed using the motor coil substrate, stable motor performance can be obtained. Even when a small motor is formed using the motor coil substrate, the motor coil substrate is unlikely to peel off from the yoke. Therefore, stable motor performance can be obtained.

In a motor coil substrate according to an embodiment of the present invention, the cylindricity of the outer circumferential surface of the motor coil substrate may be greater than 0.0 mm and equal to or less than 0.2 mm. The adhesion strength with the yoke during motor formation can be increased, and stability can be improved. Therefore, even when it is operated as a motor, the motor coil substrate is not positionally displaced, and a motor with stable performance can be obtained.

In a motor coil substrate according to an embodiment of the present invention, the cylindricity of the outer circumferential surface of the motor coil substrate may be greater than 0.0 mm and equal to or less than 0.3 mm, and the space factor of the coils in a cross section of the motor coil substrate may be 50% or more and 99% or less. The adhesion strength with the yoke during motor formation can be increased, and high torque can be obtained. A high-performance motor can be obtained.

In a motor coil substrate according to an embodiment of the present invention, the cylindricity of the outer circumferential surface of the motor coil substrate may be greater than 0.0 mm and equal to or less than 0.3 mm, and the space factor of the coils in a cross section of the motor coil substrate may be 55% or more and 90% or less. The adhesion strength with the yoke during motor formation can be increased, and a high-torque motor can be obtained. A high-performance motor can be obtained.

In a motor coil substrate according to an embodiment of the present invention, the cylindricity of the outer circumferential surface of the motor coil substrate may be greater than 0.0 mm and equal to or less than 0.3 mm, and the space factor of the coils in a cross section of the motor coil substrate may be 60% or more and 80% or less. A high space factor of the coil conductors can be ensured, and when it is wound into a cylindrical shape, a predetermined cylindrical shape can be achieved. The adhesion strength with the yoke during motor formation can be increased, and high torque can be obtained. A high-performance motor can be obtained. Further, a high space factor of the coil conductors can be ensured even in a small motor, and when it is wound into a cylindrical shape, a predetermined cylindrical shape can be achieved, the adhesion strength with the yoke during motor formation can be increased, torque can be increased, and a high-performance motor can be obtained.

In a motor coil substrate according to an embodiment of the present invention, the cylindricity of the outer circumferential surface of the motor coil substrate may be greater than 0.0 mm and equal to or less than 0.2 mm, and the space factor of the coils in a cross section of the motor coil substrate may be 50% or more and 99% or less. When the cylindricity of the outer circumferential surface of the motor coil substrate during motor formation is greater than 0.0 mm and equal to or less than 0.2 mm, the adhesion strength with the yoke can be increased, and since the space factor of the coils of the motor coil substrate is high at 50% or more and 99% or less, high torque can be obtained. Further, even when it is operated as a motor, the motor coil substrate is not positionally displaced, and a motor with stable performance can be obtained.

In a motor coil substrate according to an embodiment of the present invention, the cylindricity of the outer circumferential surface of the motor coil substrate may be greater than 0.0 mm and equal to or less than 0.2 mm, and the space factor of the coils in a cross section of the motor coil substrate may be 55% or more and 90% or less. When the cylindricity of the outer circumferential surface of the motor coil substrate during motor formation is greater than 0.0 mm and equal to or less than 0.2 mm, the adhesion strength with the yoke can be increased, and since the space factor of the coils of the motor coil substrate is high at 55% or more and 90% or less, high torque can be obtained. Further, even when it is operated as a motor, the motor coil substrate is not positionally displaced, and a motor with stable performance can be obtained.

In a motor coil substrate according to an embodiment of the present invention, the cylindricity of the outer circumferential surface of the motor coil substrate may be greater than 0.0 mm and equal to or less than 0.2 mm, and the space factor of the coils in a cross section of the motor coil substrate may be 60% or more and 80% or less. A high space factor of the coil conductors can be ensured, and when it is wound into a cylindrical shape, a predetermined cylindrical shape can be achieved. The adhesion strength with the yoke during motor formation can be increased, and high torque can be obtained. A high-performance motor can be obtained.

In a motor coil substrate according to an embodiment of the present invention, the cylindricity of the outer circumferential surface of the motor coil substrate may be greater than 0.0 mm and equal to or less than 0.3 mm, and a ratio of the wirings in a total weight of the motor coil substrate may be 80.0% or more and 99.9% or less. The space factor of the coils can be increased, and high torque can be obtained. A high-performance motor can be obtained.

In a motor coil substrate according to an embodiment of the present invention, the cylindricity of the outer circumferential surface of the motor coil substrate may be greater than 0.0 mm and equal to or less than 0.3 mm, and the ratio of the wirings in the total weight of the motor coil substrate may be 85.0% or more and 96.0% or less. The ratio of the wirings can be increased, while a predetermined cylindrical shape can be achieved. As a result, the adhesion strength with the yoke during motor formation can be increased, the space factor of the coils can be increased, and high torque can be obtained. A high-performance motor can be obtained.

In a motor coil substrate according to an embodiment of the present invention, the cylindricity of the outer circumferential surface of the motor coil substrate may be greater than 0.0 mm and equal to or less than 0.2 mm, and the ratio of the wirings in the total weight of the motor coil substrate may be 80.0% or more and 99.9% or less. The ratio of the wirings of the motor coil substrate can be increased, and the space factor of the coils can be increased, while a predetermined cylindrical shape can be achieved, and high torque can be obtained.

In a motor coil substrate according to an embodiment of the present invention, the cylindricity of the outer circumferential surface of the motor coil substrate may be greater than 0.0 mm and equal to or less than 0.2 mm, and the ratio of the wirings in the total weight of the motor coil substrate may be 85.0% or more and 96.0% or less. The ratio of the wirings can be increased, and the space factor of the coils can be increased, while a predetermined cylindrical shape can be achieved, and high torque can be obtained. As a result, the adhesion strength with the yoke during motor formation can be increased, and stability can be improved. Therefore, even when it is operated as a motor, the motor coil substrate is not positionally displaced, and a motor with stable performance can be obtained.

In a motor coil substrate according to an embodiment of the present invention, the cylindricity of the outer circumferential surface of the motor coil substrate may be greater than 0.0 mm and equal to or less than 0.3 mm, the space factor of the coils in a cross section of the motor coil substrate may be 50% or more and 99% or less, and the ratio of the wirings in the total weight of the motor coil substrate may be 80.0% or more and 99.9% or less. The space factor of the coils can be increased, and high torque can be obtained. The adhesion strength with the yoke during motor formation can be increased, and high torque can be obtained. A high-performance motor can be obtained.

In a motor coil substrate according to an embodiment of the present invention, the cylindricity of the outer circumferential surface of the motor coil substrate may be greater than 0.0 mm and equal to or less than 0.3 mm, the space factor of the coils in a cross section of the motor coil substrate may be 55% or more and 90% or less, and the ratio of the wirings in the total weight of the motor coil substrate may be 80.0% or more and 99.9% or less. The space factor of the coils can be increased, a specified cylindrical shape can be achieved, and a high-torque motor can be obtained. Therefore, even when it is operated as a motor, a motor with stable performance can be obtained.

In a motor coil substrate according to an embodiment of the present invention, the cylindricity of the outer circumferential surface of the motor coil substrate may be greater than 0.0 mm and equal to or less than 0.3 mm, the space factor of the coils in a cross section of the motor coil substrate may be 60% or more and 80% or less, and the ratio of the wirings in the total weight of the motor coil substrate may be 80.0% or more and 99.9% or less. A high space factor of the coil conductors can be ensured, and when it is wound into a cylindrical shape, a predetermined cylindrical shape can be achieved. High torque can be obtained.

In a motor coil substrate according to an embodiment of the present invention, the cylindricity of the outer circumferential surface of the motor coil substrate may be greater than 0.0 mm and equal to or less than 0.2 mm, the space factor of the coils in a cross section of the motor coil substrate may be 50% or more and 99% or less, and the ratio of the wirings in the total weight of the motor coil substrate may be 80.0% or more and 99.9% or less. The space factor of the coils can be increased, and high torque can be obtained. The adhesion strength with the yoke during motor formation can be increased, and high torque can be obtained. A high-performance motor can be obtained. Further, even when it is operated as a motor, the motor coil substrate is not positionally displaced, and a motor with stable performance can be obtained.

In a motor coil substrate according to an embodiment of the present invention, the cylindricity of the outer circumferential surface of the motor coil substrate may be greater than 0.0 mm and equal to or less than 0.2 mm, the space factor of the coils in a cross section of the motor coil substrate may be 55% or more and 90% or less, and the ratio of the wirings in the total weight of the motor coil substrate may be 80.0% or more and 99.9% or less. The space factor of the coils can be increased, a specified cylindrical shape can be achieved, and a high-torque motor can be obtained. Therefore, even when it is operated as a motor, a motor with stable performance can be obtained.

In a motor coil substrate according to an embodiment of the present invention, the cylindricity of the outer circumferential surface of the motor coil substrate may be greater than 0.0 mm and equal to or less than 0.2 mm, the space factor of the coils in a cross section of the motor coil substrate may be 60% or more and 80% or less, and the ratio of the wirings in the total weight of the motor coil substrate may be 80.0% or more and 99.9% or less. A high space factor of the coil conductors can be ensured, and when it is wound into a cylindrical shape, a predetermined cylindrical shape can be achieved. High torque can be obtained.

In a motor coil substrate according to an embodiment of the present invention, the cylindricity of the outer circumferential surface of the motor coil substrate may be greater than 0.0 mm and equal to or less than 0.3 mm, the space factor of the coils in a cross section of the motor coil substrate may be 50% or more and 99% or less, and the ratio of the wirings in the total weight of the motor coil substrate may be 85.0% or more and 96.0% or less. The space factor of the coils can be increased, and high torque can be obtained. The adhesion strength with the yoke during motor formation can be increased, and high torque can be obtained. A high-performance motor can be obtained. Further, when it is wound into a cylinder, a predetermined cylindrical shape can be achieved.

In a motor coil substrate according to an embodiment of the present invention, the cylindricity of the outer circumferential surface of the motor coil substrate may be greater than 0.0 mm and equal to or less than 0.3 mm, the space factor of the coils in a cross section of the motor coil substrate may be 55% or more and 90% or less, and the ratio of the wirings in the total weight of the motor coil substrate may be 85.0% or more and 96.0% or less. The space factor of the coils can be increased, a specified cylindrical shape can be achieved, and a high-torque motor can be obtained. Therefore, even when it is operated as a motor, a motor with stable performance can be obtained.

In a motor coil substrate according to an embodiment of the present invention, the cylindricity of the outer circumferential surface of the motor coil substrate may be greater than 0.0 mm and equal to or less than 0.3 mm, the space factor of the coils in a cross section of the motor coil substrate may be 60% or more and 80% or less, and the ratio of the wirings in the total weight of the motor coil substrate may be 85.0% or more and 96.0% or less. A high space factor of the coil conductors can be ensured, and when it is wound into a cylindrical shape, a predetermined cylindrical shape can be achieved. High torque can be obtained.

In a motor coil substrate according to an embodiment of the present invention, the cylindricity of the outer circumferential surface of the motor coil substrate may be greater than 0.0 mm and equal to or less than 0.2 mm, the space factor of the coils in a cross section of the motor coil substrate may be 50% or more and 99% or less, and the ratio of the wirings in the total weight of the motor coil substrate may be 80.0% or more and 96.0% or less. The space factor of the coils can be increased, and high torque can be obtained. The adhesion strength with the yoke during motor formation can be increased, and high torque can be obtained. A high-performance motor can be obtained. Further, even when it is operated as a motor, the motor coil substrate is not positionally displaced, and a motor with stable performance can be obtained.

In a motor coil substrate according to an embodiment of the present invention, the cylindricity of the outer circumferential surface of the motor coil substrate may be greater than 0.0 mm and equal to or less than 0.2 mm, the space factor of the coils in a cross section of the motor coil substrate may be 55% or more and 90% or less, and the ratio of the wirings in the total weight of the motor coil substrate may be 85.0% or more and 96.0% or less. The space factor of the coils can be increased, a specified cylindrical shape can be achieved, and a high-torque motor can be obtained. Therefore, even when it is operated as a motor, a motor with stable performance can be obtained.

In a motor coil substrate according to an embodiment of the present invention, the cylindricity of the outer circumferential surface of the motor coil substrate may be greater than 0.0 mm and equal to or less than 0.2 mm, the space factor of the coils in a cross section of the motor coil substrate may be 60% or more and 80% or less, and the ratio of the wirings in the total weight of the motor coil substrate may be 85.0% or more and 96.0% or less. A high space factor of the coil conductors can be ensured, and when it is wound into a cylindrical shape, a predetermined cylindrical shape can be achieved. High torque can be obtained. As a result, the adhesion strength with the yoke during motor formation can be increased, and stability can be improved.

In a motor coil substrate according to an embodiment of the present invention, the coils may each have a half-turn first wiring formed on the first surface, a half-turn second wiring formed on the second surface, and a via conductor connecting the first wiring and the second wiring.

In a motor coil substrate according to an embodiment of the present invention, the coils may each have a first wiring formed in a spiral shape on the first surface, a second wiring formed in a spiral shape on the second surface, and a via conductor connecting the first wiring and the second wiring.

In a motor coil substrate according to an embodiment of the present invention, the motor coil substrate may be used in a slotless motor.

In a motor coil substrate according to an embodiment of the present invention, it is also possible that the outer circumferential surface is formed by the flexible substrate, and the wirings are not exposed.

In a motor coil substrate according to an embodiment of the present invention, an insulating layer that covers the wirings may be formed on an outermost circumference of the motor coil substrate.

In a motor coil substrate according to an embodiment of the present invention, the motor coil substrate may have an outer diameter of 50 mm or less.

In a motor coil substrate according to an embodiment of the present invention, the motor coil substrate may have an outer diameter of 30 mm or less.

A motor according to an embodiment of the present invention is formed by positioning the above motor coil substrate of the present invention on an inner side of a cylindrical yoke, and positioning a rotation shaft and a magnet on an inner side of the motor coil substrate.

In a motor according to an embodiment of the present invention, the adhesion strength between the outer circumferential surface of the motor coil substrate and the yoke is high. Even when a reaction force is exerted due to the rotation of the rotation shaft and the magnet, the motor coil substrate is unlikely to peel off from the yoke. In particular, when a small motor is manufactured, a wider contact area between the outer circumferential surface of the motor coil substrate and the yoke is ensured, resulting in higher adhesion strength. Therefore, stable motor performance can be obtained. Even when a small motor is formed, stable motor performance can be obtained.

Obviously, numerous modifications and variations of the present invention are possible in light of the above teachings. It is therefore to be understood that within the scope of the appended claims, the invention may be practiced otherwise than as specifically described herein.

1. A motor coil substrate, comprising:
a flexible substrate; and
a plurality of coils comprising a plurality of wirings such that the wirings are formed on a first surface of the flexible substrate and a second surface on an opposite side with respect to the first surface,
wherein the flexible substrate is configured to be wound circumferentially from one end of a longitudinal direction of a flexible substrate around an axis extending in a direction perpendicular to the longitudinal direction of the flexible substrate such that the flexible substrate is formed into a cylindrical shape and that a cylindricity of an outer circumferential surface is greater than 0.0 mm and equal to or less than 0.3 mm.

2. The motor coil substrate according to claim 1, wherein the flexible substrate is configured to be wound circumferentially around the axis extending in the direction perpendicular to the longitudinal direction of the flexible substrate such that the cylindricity of the outer circumferential surface of the motor coil substrate is greater than 0.0 mm and equal to or less than 0.2 mm.

3. The motor coil substrate according to claim 1, wherein the flexible substrate is configured to be wound circumferentially around the axis extending in the direction perpendicular to the longitudinal direction of the flexible substrate such that the outer circumferential surface is formed by the flexible substrate and that the wirings are not exposed.

4. The motor coil substrate according to claim 1, wherein the plurality of coils is formed such that each of the coils has a half-turn first wiring formed on the first surface, a half-turn second wiring formed on the second surface, and a via conductor connecting the first wiring and the second wiring.

5. The motor coil substrate according to claim 1, wherein the plurality of coils is formed such that each of the coils has a first wiring formed in a spiral shape on the first surface of the flexible substrate, a second wiring formed in a spiral shape on the second surface of the flexible substrate, and a via conductor connecting the first wiring and the second wiring through the flexible substrate.

6. A slotless motor, comprising:
the motor coil substrate of claim 1.

7. The motor coil substrate according to claim 1, wherein the flexible substrate is configured to be wound circumferentially around the axis extending in the direction perpendicular to the longitudinal direction of the flexible substrate such that the motor coil substrate has a cross section having an outer diameter of 50 mm or less.

8. The motor coil substrate according to claim 1, wherein the plurality of coils is formed such that a space factor of the coils in a cross section of the motor coil substrate is in a range of 50% to 99%.

9. The motor coil substrate according to claim 1, wherein the plurality of coils is formed such that a ratio of the wirings in a total weight of the motor coil substrate is in a range of 80.0% to 99.9%.

10. The motor coil substrate according to claim 1, wherein the plurality of coils is formed such that a space factor of the coils in a cross section of the motor coil substrate is in a range of 50% to 99% and that a ratio of the wirings in a total weight of the motor coil substrate is in a range of 80.0% to 99.9%.

11. The motor coil substrate according to claim 1, wherein the plurality of coils is formed such that a space factor of the coils in a cross section of the motor coil substrate is in a range of 60% to 80% and that a ratio of the wirings in a total weight of the motor coil substrate is in a range of 80.0% to 99.9%.

12. The motor coil substrate according to claim 1, further comprising:
an insulating layer covering the plurality of wirings such that the insulating layer is formed on an outermost circumference of the motor coil substrate.

13. A motor, comprising:
a cylindrical yoke;
a motor coil substrate positioned on an inner side of the cylindrical yoke;
a magnet positioned on an inner side of the motor coil substrate; and
a rotation shaft positioned on the inner side of the motor coil substrate,
wherein the motor coil substrate is the motor coil substrate of claim 1.

14. The motor coil substrate according to claim 2, wherein the flexible substrate is configured to be wound circumferentially around the axis extending in the direction perpendicular to the longitudinal direction of the flexible substrate such that the outer circumferential surface is formed by the flexible substrate and that the wirings are not exposed.

15. The motor coil substrate according to claim 2, wherein the plurality of coils is formed such that each of the coils has a half-turn first wiring formed on the first surface, a half-turn second wiring formed on the second surface, and a via conductor connecting the first wiring and the second wiring.

16. The motor coil substrate according to claim 2, wherein the plurality of coils is formed such that each of the coils has a first wiring formed in a spiral shape on the first surface of the flexible substrate, a second wiring formed in a spiral shape on the second surface of the flexible substrate, and a via conductor connecting the first wiring and the second wiring through the flexible substrate.

17. The motor coil substrate according to claim 2, wherein the flexible substrate is configured to be wound circumferentially around the axis extending in the direction perpendicular to the longitudinal direction of the flexible substrate such that the motor coil substrate has a cross section having an outer diameter of 50 mm or less.

18. The motor coil substrate according to claim 2, wherein the plurality of coils is formed such that a space factor of the coils in a cross section of the motor coil substrate is in a range of 50% to 99%.

19. The motor coil substrate according to claim 2, wherein the plurality of coils is formed such that a ratio of the wirings in a total weight of the motor coil substrate is in a range of 80.0% to 99.9%.

20. The motor coil substrate according to claim 2, wherein the plurality of coils is formed such that a space factor of the coils in a cross section of the motor coil substrate is in a range of 50% to 99% and that a ratio of the wirings in a total weight of the motor coil substrate is in a range of 80.0% to 99.9%.
